(19) United States
(12) Patent Application Publication
(10) Pub. No.: US 2018/0186216 A1
(43) Pub. Date: Jul. 5, 2018

(54) REFRIGERATION CYCLE OF VEHICLE AIR CONDITIONER

(71) Applicant: Hanon Systems, Daejeon (KR)

(72) Inventors: Jun Young SONG, Daejeon (KR); Dong Suk LEE, Daejeon (KR); Sun Mi LEE, Daejeon (KR); Hong-Young LIM, Daejeon (KR); Wi Sam JO, Daejeon (KR)

(21) Appl. No.: 15/529,369

(22) PCT Filed: Apr. 19, 2016
(86) PCT No.: PCT/KR2016/004041

§ 371 Date: May 24, 2017

(30) Foreign Application Priority Data
Jun. 15, 2015 (KR) 10-2015-0083978

(51) Int. Cl. B60H 1/32; F25B 6/04; F25B 39/04; F25B 40/02; F28D 1/053; B60H 1/00

(52) U.S. Cl. CPC B60H 1/323; F25B 6/04; F25B 39/04; F25B 40/02; F28D 2021/0063; B60H 1/00885; B60H 1/3211; F25B 2339/047; F28D 1/05325

(57) ABSTRACT

The present invention relates to a refrigeration cycle of a vehicle air conditioner and, more specifically, to a refrigeration cycle of a vehicle air conditioner including a water cooling type condenser and an air cooling type condenser and being configured so that a refrigerant, which is in an abnormal state after passing through a condensed region of the air cooling type condenser, passes through the water cooling type condenser and then passes through a supercooled region of the air cooling type condenser.

### TECHNICAL FIELD

The present invention relates to a refrigeration cycle of a vehicle air conditioner and, more specifically, to a refrigeration cycle of a vehicle air conditioner including a water cooling type condenser and an air cooling type condenser and being configured so that a refrigerant, which is in an abnormal state after passing through a condensed region of the air cooling type condenser, passes through the water cooling type condenser and then passes through a supercooled region of the air cooling type condenser.

### BACKGROUND ART

In a refrigeration cycle of a general vehicle air conditioner, an actual cooling operation is performed by an evaporator in which a liquefied heat exchange medium absorbs heat therearound as much as vaporization heat and is vaporized. A gaseous heat exchange medium that is introduced into a compressor from the evaporator is compressed at a high temperature and a high pressure by the compressor, liquefaction heat is discharged to the periphery during liquefaction while the compressed gaseous heat exchange medium is liquefied by passing through the condenser, and the liquefied heat exchange medium is in a low-temperature and low-pressure wet saturated vapor state by passing through an expansion valve again and then is introduced into the evaporator again to be vaporized, to thereby form a cycle.

That is, the condenser is introduced with a high-temperature and high-pressure gaseous refrigerant and condenses and discharges the refrigerant in the liquid state while the refrigerant discharging the liquefaction heat by heat exchange, in which as the heat exchange medium cooling the refrigerant, air cooling type using air and water cooling type using a liquid may be used.

The air cooling type condenser is configured to exchange heat with air introduced through an opening on a front part of a vehicle, and is generally fixed to a front side of the vehicle with which a bumper beam is formed to smoothly exchange heat with air.

Meanwhile, in the condenser constituting the refrigeration cycle of the vehicle air conditioner, both an air cooling type condenser 12 and a water cooling type condenser 11 may be used to increase heat exchange efficiency.

In an air cooling type air conditioner system using the existing air cooling type condenser, the condenser is located at the front part of the vehicle, and thus there is a disadvantage in which a configuration of a refrigerant line is long and complicated, and the condenser performance is sensitive to the outside air temperature.

On the other hand, in a water cooling type air conditioner system using the water cooling type condenser, a temperature range of cooling water is not larger than air and therefore stable cooling performance may be ensured and the air cooling type condenser of the front part of the vehicle is removed and therefore a package of the front part of the vehicle may be improved.

However, the water cooling type condenser uses cooling water of a low temperature radiator instead of air to condense the refrigerant. At this point, the cooling water temperature of the low temperature radiator is higher than the external air temperature, and therefore efficiency is reduced when the water cooling type condenser is used alone. For this reason, an air cooling part is formed at a back end of a water cooling part and an internal heat exchange function is added, thereby improving the efficiency.

At this point, as illustrated in FIG. 1, the water cooling type condenser 11 is mounted inside an outlet tank of the low temperature radiator (LTR). In this case, there is a disadvantage in that a pressure drop amount of the cooling water side of the low temperature radiator may be increased, the assembling is complicated, and the A/S is difficult to perform.

As the related technique, a cooling structure in which a refrigerant passes through an air cooling type condenser via a water cooling type condenser is disclosed in Japanese Patent Laid-Open Publication No. 2005-343221 (published on Dec. 15, 2005, entitled Cooling Apparatus Structure of Vehicle, hereinafter referred to as prior patent).

However, the above-mentioned prior patent discloses the system in which the water cooling type condenser is mounted at an outlet of the air cooling type condenser and therefore performance degradation may occur due to an insufficient cooling water heat source and cooling water having high specific heat is not used as a heat source in the abnormal region of the refrigerant having high exchange efficiency but air is used as a heat source in the abnormal region of the refrigerant, and therefore there is a limitation of improving heat exchange performance.

### DISCLOSURE

### Technical Problem

An object of the present invention is to provide a refrigeration cycle of a vehicle air conditioner including a water cooling type condenser and an air cooling type condenser and being configured so that a refrigerant, which is in an abnormal state after passing through a condensed region of the air cooling type condenser, passes through the water cooling type condenser and then passes through a supercooled region of the air cooling type condenser to improve cooling performance.

### Technical Solution

In one general aspect, a refrigeration cycle of a vehicle air conditioner, includes: a compressor C compressing a refrigerant; a water cooling type condenser 10 exchanging heat between cooling water introduced from a low-temperature radiator and a refrigerant passing through the compressor C; an air cooling type condenser 20 introduced with the refrigerant, compressed by the compressor C and discharged, through a first inlet 201 to exchange heat between the refrigerant and air so as to condense the refrigerant, discharging the refrigerant passing through a condensed region A1 through a first outlet 202 to pass the refrigerant through the water cooling type condenser 10, introduced with the refrigerant through a second inlet 203, and then passing the refrigerant through a supercooled region A2 to exchange heat between the refrigerant and the air; an expansion valve T expanding the refrigerant that passes through the supercooled region A2 of the air cooling type condenser 20 and is then discharged through the second outlet 204; and an evaporator E evaporating the refrigerant that is expanded by the expansion valve T and discharged, all of which are connected to each other by a refrigerant pipe P.

The refrigerant discharged through the first outlet 202 of the air cooling type condenser 20 to be introduced into the water cooling type condenser 10 may be in an abnormal state in which gas and liquid are mixed.

The air cooling type condenser 20 may include: a first header tank 210 and a second header tank 220 having the refrigerant introduced or discharged thereinto or therefrom and disposed in parallel while being spaced apart from each other by a predetermined distance in a height direction or a longitudinal direction; a plurality of tubes having both ends fixed to the first and second header tanks 210 and 220 to form a refrigerant channel; a plurality of fins interposed between the tubes; and a gas-liquid separator 230 connected to the second header tank 220 and having a body introduced with the refrigerant passing through the water cooling type condenser 10 to perform gas-liquid separation.

In the air cooling type condenser 20, the first inlet 201, the first outlet 202, the second inlet 203, and the second outlet 204 may be formed in the first header tank 210.

In the air cooling type condenser 20, the first inlet 201 and the second outlet 204 may be formed in the first header tank 210 and the first outlet 202 and the second inlet 203 may be formed in the second header tank 220.

In the air cooling type condenser 20, the first inlet 201, the first outlet 202, and the second outlet 204 may be formed in the first header tank 210 or the second header tank 220 and the second inlet 203 may be formed in the gas-liquid separator 230.

The water cooling type condenser 10 may include: a housing part 110 provided with a cooling water inlet 111 and a cooling water outlet 112; and a fin-tube type water cooling heat exchanger 120 that is accommodated in the housing part 110 and has the refrigerant discharged through the first outlet 202 introduced thereinto to circulate the refrigerant so as to exchange heat between the refrigerant and the cooling water.

The water cooling heat exchanger 120 may be formed in any one of a shell-tube type and a plate type.

The gas-liquid separator 230 and the water cooling type condenser 10 may be integrally formed.

### Advantageous Effects

Accordingly, the refrigeration cycle of a vehicle air conditioner includes both of the water cooling type condenser and the air cooling type condenser and is configured so that the refrigerant, which is in the abnormal state after passing through the condensed region of the air cooling type condenser, passes through the water cooling type condenser and then passes through the supercooled region of the air cooling type condenser, thereby improving the cooling performance.

That is, according to the present invention, in order to supplement the disadvantage of the water cooling type condenser in which the cooling efficiency may be reduced when the water cooling type condenser is used alone but the stable cooling performance may be ensured, both the water cooling type condenser and the air cooling type condenser are used but the water cooling type condenser is disposed in the abnormal region of the refrigerant having the high heat exchange efficiency, thereby improving the cooling performance.

Further, the present invention may change the number of refrigerant passes of the air cooling type condenser according to the system load by using the baffle and may be applied not only to the cross flow type but also to the down flow type, and the water cooling type condenser is not limited in the form and therefore may be easily applied without being greatly changed in the existing system.

In addition, according to the present invention, the gas-liquid separator of the air cooling type condenser and the water cooling type condenser may be integrally formed, thereby simplifying the package and improving the space utilization.

### DESCRIPTION OF DRAWINGS

FIG. 1 is a schematic view illustrating a refrigeration cycle of a vehicle air conditioner including the existing hybrid type condenser.

FIG. 2 is a view illustrating an arrangement of the existing hybrid type condenser on a PH diagram.

FIG. 3 is a schematic diagram illustrating a refrigeration cycle of a vehicle air conditioner according to the present invention.

FIG. 4 is a diagram illustrating an arrangement of an air cooling type condenser and a water cooling type condenser according to the present invention on the PH diagram.

FIGS. 5 to 10 are schematic diagrams illustrating various examples of the air cooling type condenser and the water cooling type condenser according to the present invention.

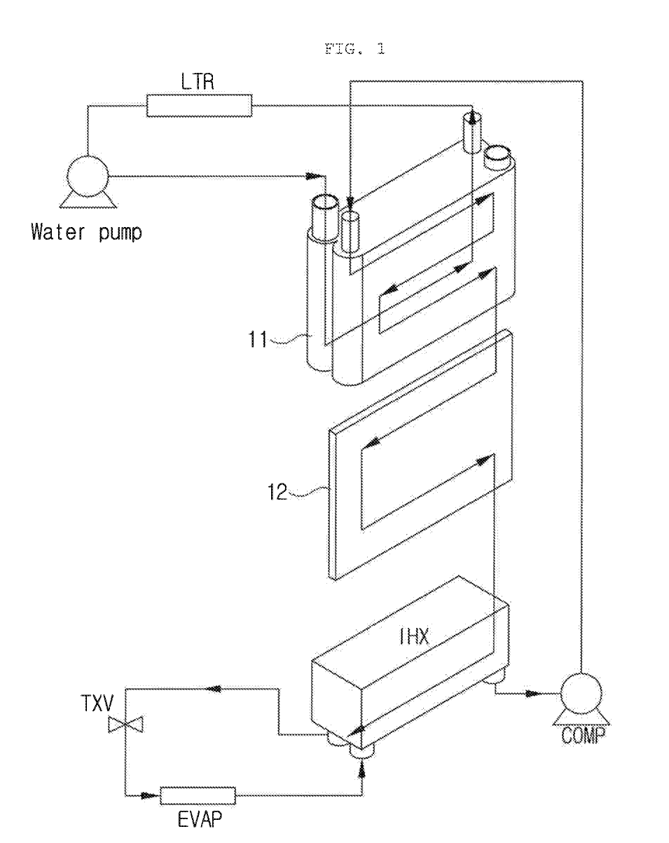

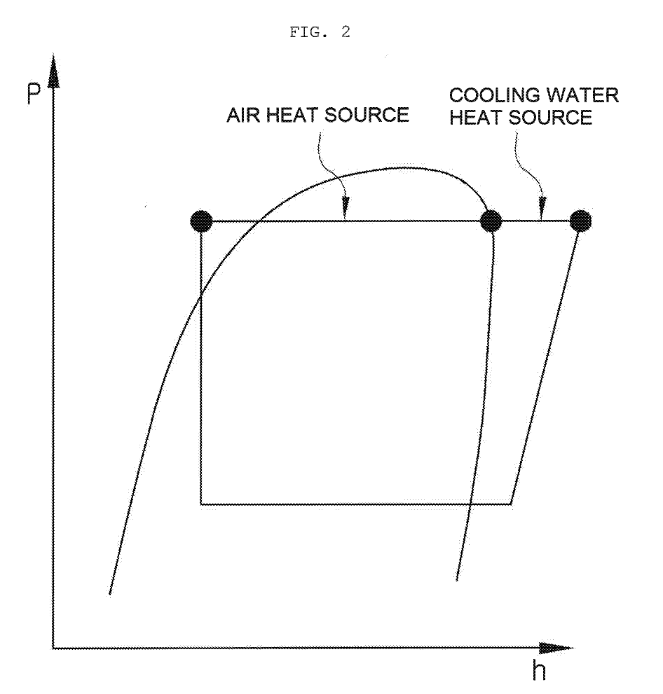

### BEST MODE

Hereinafter, a refrigeration cycle of a vehicle air conditioner according to the present invention as described above will be described in detail with reference to the accompanying drawings.

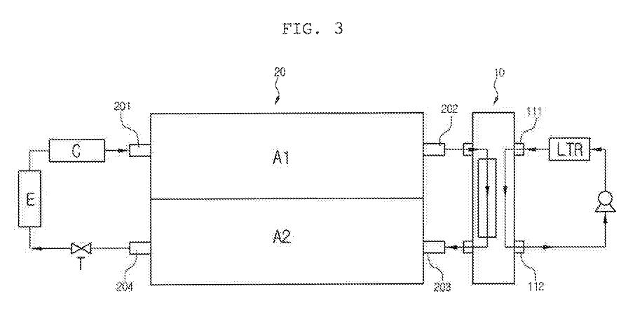

As illustrated in FIG. 3, a refrigeration cycle of a vehicle air conditioner according to the present invention includes: a compressor C compressing a refrigerant, a water cooling type condenser 10 condensing a refrigerant, which is compressed by the compressor C and discharged, by exchanging heat between the refrigerant and cooling water; an air cooling type condenser 20 condensing the refrigerant by exchanging heat between the refrigerant and air; an expansion valve T expanding the refrigerant condensed by the air cooling type condenser 20 and discharged; and an evaporator E evaporating the refrigerant expanded by the expansion valve T and discharged, all of which are connected to each other by a refrigerant pipe P.

First, the compressor C is operated by receiving power from a power supply source (engine, motor, or the like) and sucks and compresses a low-temperature and low-pressure gaseous refrigerant discharged from the evaporator E, thereby discharging the refrigerant in a high-temperature and low-pressure gaseous state.

In the air cooling type condenser 20, the high-temperature and high-pressure gaseous refrigerant, which is compressed by the compressor C and discharged, is introduced through a first inlet 201 to exchange heat with air and a refrigerant passing through a condensed region A1 is discharged through a first outlet 202.

Thereafter, the refrigerant passes through the water cooling type condenser, and then is introduced through a second inlet 203 of the air cooling type condenser 20 and is discharged through the second outlet 204 through the supercooled region A2.

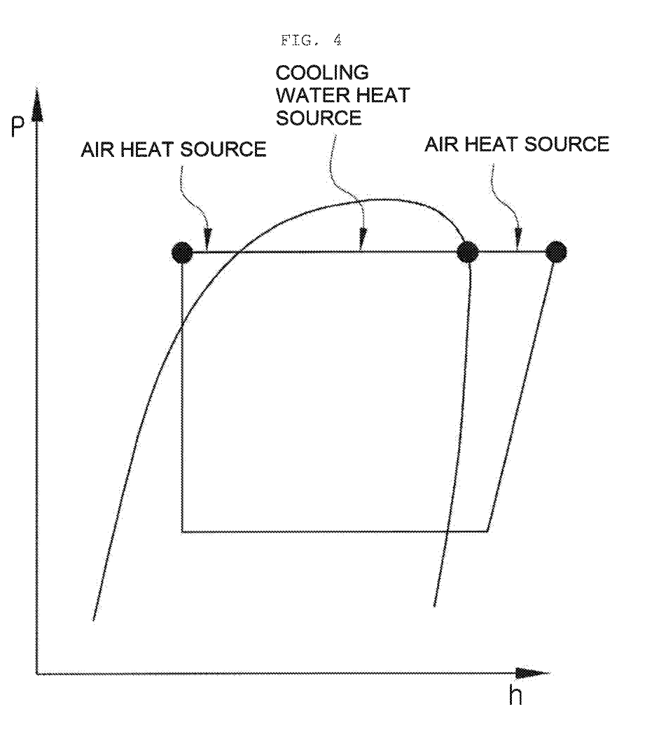

That is, as illustrated in FIG. 4, in the refrigeration cycle of the vehicle air conditioner according to the present invention, the air cooling type condenser 20 and the water cooling type condenser 10 are both used in the order of air, cooling water and air as the heat source for condensing the refrigerant. Here, the refrigerant that is discharged through the first outlet 202 of the air cooling type condenser 20 and is introduced into the water cooling type condenser 10 is in the abnormal state that is a state in which gas and liquid are mixed and the water cooling type condenser 10 is disposed in an abnormal region of which the refrigerant having high heat exchange efficiency, thereby improving the cooling efficiency.

The expansion valve rapidly expands the liquefied refrigerant discharged from the air cooling type condenser 20 by a throttling action to supply the refrigerant to an evaporator E in a low-temperature and low-pressure wet saturated state.

The evaporator evaporates a low-pressure liquefied refrigerant throttled in the expansion valve T by exchanging heat with air ventilated to a vehicle interior within an air conditioning case, thereby cooling the air discharged into the interior due to a heat adsorption action by evaporation latent heat of the refrigerant.

Subsequently, the low-temperature and low-pressure gaseous refrigerant, which is evaporated by the evaporator (E) and discharged, is sucked into the compressor C again and re-circulates the refrigeration cycle as described above.

In addition, in the refrigerant circulation process described above, the cooling of the vehicle interior is made by introducing air ventilated from a blower (not illustrated) into the air conditioning case and cooling the air with the evaporation latent heat of the liquefied refrigerant circulating the inside of the evaporator E while passing the air through the evaporator E to discharge the air to the vehicle interior in the cooled state.

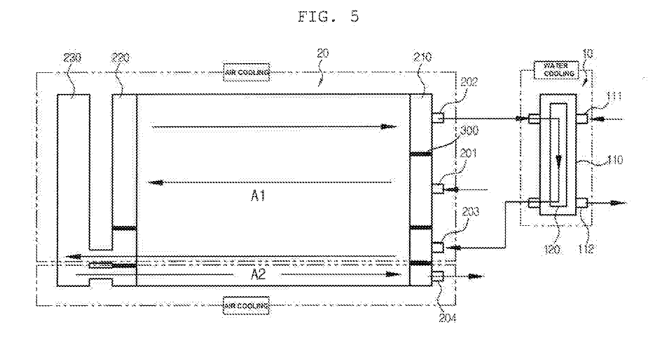

Hereinafter, the air cooling type condenser 20 and the water cooling type condenser 10 included in the refrigeration cycle of the vehicle air conditioner according to the present invention will be described in detail with reference to FIGS. 5 to 10.

The air cooling type condenser 20 includes a first header tank 210 and a second header tank 220 having the refrigerant introduced or discharged thereinto or therefrom and disposed in parallel while being spaced apart from each other by a predetermined distance in a height direction or a longitudinal direction, a plurality of tubes (not illustrated) having both ends fixed to the first and second header tanks 210 and 220 to form a refrigerant channel, a plurality of fins (not illustrated) interposed between the tubes, and a gas-liquid separator 230 connected to the second header tank 220 and having a body introduced with the refrigerant passing through the water cooling type condenser 10 to perform gas-liquid separation.

The first header tank 210 or the second header tank 220 is provided with a first inlet 201 through which the refrigerant is introduced from the compressor C, a first outlet 202 through which the refrigerant is discharged to the water cooling type condenser 10 via the condensed region A1, a second inlet 203 through which the refrigerant circulating the water cooling type condenser 10 is introduced, and a second outlet 204 through which the refrigerant is discharged to the expansion valve T via the supercooled region A2.

At this point, the air cooling type condenser 20 may be formed as a down flow type or a cross flow type. In the case of the down flow type, the first header tank 210 and the second header tank 220 are provided in parallel while being spaced apart from each other by a predetermined distance in a longitudinal direction and in the case of the cross flow type, the first header tank 210 and the second header tank 220 are provided in parallel while being spaced apart from each other by a predetermined distance in a height direction.

The water cooling type condenser 10 is configured to include a housing part 110 that includes a cooling water inlet into which the cooling water is introduced from a low-temperature radiator and a cooling water outlet through which the cooling water is discharged and has a certain space formed therein.

Further, the water cooling type condenser 10 may include a fin-tube type water cooling heat exchanger 120 that is accommodated in the housing part 110 and has the refrigerant discharged through the first outlet 202 of the air cooling type condenser 20 introduced thereinto to circulate the refrigerant so as to exchange heat between the refrigerant and the cooling water.

In addition, the water cooling heat exchanger 120 may be changed to any one of a shell-tube type having a double tube form and a plate type.

Further, as long as the air cooling type condenser 20 and the water cooling type condenser are connected so that the refrigerant discharged from the compressor C passes through the air cooling type condenser 20, the water cooling type condenser 10, and the air cooling type condenser 20 in order, the number of passes or the form thereof may be variously changed without any limitation.

First, referring to FIG. 5, the air cooling type condenser 20 is the cross flow type heat exchanger in which the first header tank 210 and the second header tank 220 are spaced apart from each other by a predetermined distance in the longitudinal direction, in which the first header tank 210 is provided with the first inlet 201, the first outlet 202, the second inlet 203, and the second outlet 204 and the air cooling type condenser 20 is connected to the water cooling type condenser through the first outlet 202 and the second inlet 203.

That is, in FIG. 5, one side of the air cooling type condenser 20 is provided with the water cooling type condenser 10 and the other side thereof is provided with the gas-liquid separator 230.

At this time, the water cooling type condenser 10 may be formed integrally with the air cooling type condenser 20.

The refrigerant discharged from the compressor C and introduced into the air cooling type condenser 20 is introduced through the first inlet 201 formed in a certain region of a middle portion of the first header tank 210, flows in the second header tank 220 via the tube, and then moves upwardly to again flow in the water cooling type condenser 10 through the first outlet 202 formed in an upper region of the first header tank 210 via the tube.

The refrigerant introduced into the water cooling type condenser 10 is introduced from the low-temperature radiator and exchanges heat with the cooling water of the water cooling type condenser 10, and then flows in the air cooling type condenser 20 through the second inlet 203.

The refrigerant that moves from the first header tank 210 of the air cooling type condenser 20 to the second header tank 220 through the tube is gas-liquid separated by the gas-liquid separator 230, and then discharged to the second outlet 204 of the first header tank 210 through the supercooled region A2 formed in the lowermost region of the air cooling type condenser 20.

In the air cooling type condenser 20 of FIG. 5, two baffles are installed in the second header tank 220 and three baffles are installed in the first header tank 210, and thus the refrigerant flow is performed as described above.

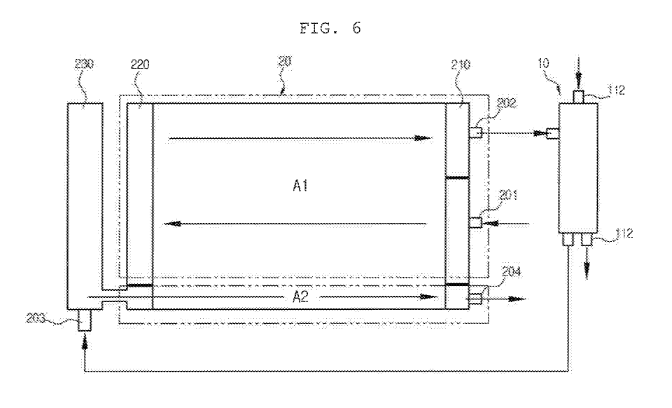

Next, referring to FIG. 6, the air cooling type condenser 20 is the down flow type heat exchanger, in which the first inlet 201, the first outlet 202, and the second outlet 204 are form in the first header tank 210 or the second header tank 220, in particular, the second inlet 203 is formed in the gas-liquid separator 230 to directly pass the refrigerant, which has passed through the water cooling type condenser 20, through the supercooled region A2.

At this point, one side of the air cooling type condenser 20 is provided with the water cooling type condenser 10 and the other side thereof is provided with the gas-liquid separator 230, and thus the water cooling type condenser 20 and the second inlet 202 are connected to each other through a separate pipe.

The refrigerant introduced from the compressor C is introduced through the first inlet 201 formed in a certain region of the middle portion of the first header tank 210, flows in the second header tank 220 via the tube (1 path), and then moves upwardly to again flow in the water cooling type condenser 10 through the first outlet 202 formed in the upper region of the first header tank 210 via the tube (2 path).

The refrigerant introduced into the water cooling type condenser 10 is introduced from the low-temperature radiator to exchange heat with the cooling water of the water cooling type condenser 10, directly passes through the gas-liquid separator 230 through the second inlet 203 formed in the gas-liquid separator 230, and then is discharged to the second outlet 204 via the supercooled region A2 of the air cooling type condenser 20 (3 path).

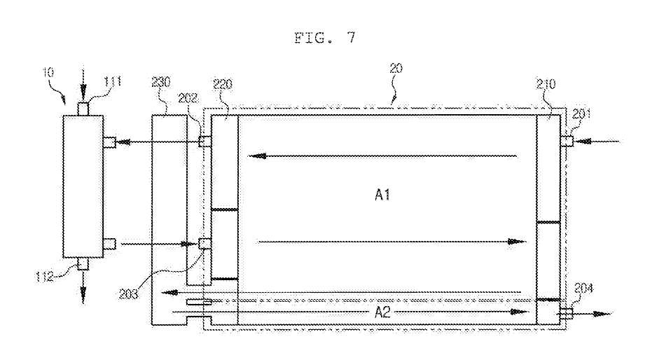

Next, referring to FIG. 7, the air cooling type condenser 20 is the down flow type heat exchanger, and in the air cooling type condenser 20, the first header tank 210 is provided with the first inlet 201 and the second outlet 204 and the second header tank 220 is provided with the first outlet 202 and the second inlet 203.

At this point, as illustrated in FIG. 7, the water cooling type condenser 10 is not disposed at the first header tank 210 where the first inlet 201 of the air cooling type condenser 20 is formed but at the portion where the gas-liquid separator 230 is formed.

The refrigerant introduced from the compressor C is introduced through the first inlet 201 formed in the first header tank 210, flows in the first header tank 210 through the tube (1 path), and then flows in the water cooling type condenser 10 through the first outlet 202.

The refrigerant introduced into the water cooling type condenser 10 is introduced from the low-temperature radiator to exchange heat with the cooling water of the water cooling type condenser 10, flows in the second header tank 220 through the second inlet 203, flows in the first heater tank 210 via the tube (2 path), and then again moves downwardly to flow in the second header tank 220 via the tube (3 path).

Next, the refrigerant passes through the gas-liquid separator 230 and then passes through the supercooled region A2 to be discharged to the second outlet 204 of the first header tank 210 (4 path).

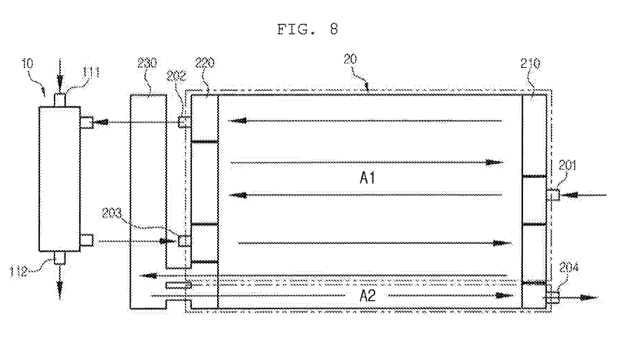

Next, like the air cooling type condenser 20 of FIG. 7, in the air cooling type condenser 20 according to the embodiment of FIG. 8, the first header tank 210 is provided with the first inlet 201 and the second outlet 204 and the second heater tank 220 is provided with the first outlet 202 and the second inlet 203.

At this point, as illustrated in FIG. 7, the water cooling type condenser 10 is not disposed at the first header tank 210 where the first inlet 201 of the air cooling type condenser 20 is formed but at the portion where the gas-liquid separator 230 is formed.

However, in the air cooling type condenser 20 of FIG. 8, three baffles are provided in each of the first and second header tanks 210 and 220 to provide 6 paths.

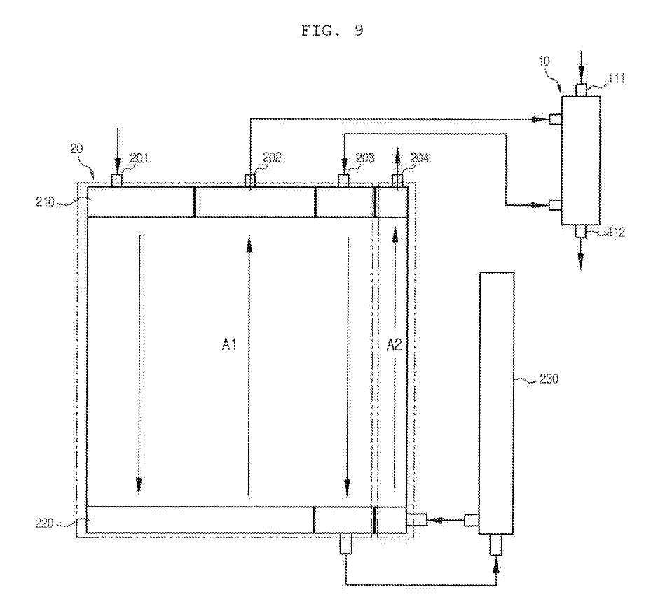

In the embodiment of FIG. 9, the air cooling type condenser 20 and the water cooling type condenser have the same flow as in FIG. 5, but have a difference in that the air cooling type condenser 20 is a down flow type heat exchanger.

Like FIG. 5, in the air cooling type condenser 20 of FIG. 9, the first header tank 210 is provided with the first inlet 201, the first outlet 202, the second inlet 203, and the second outlet 204 and the air cooling type condenser 20 is connected to the water cooling type condenser 10 through the first outlet 202 and the second inlet 203.

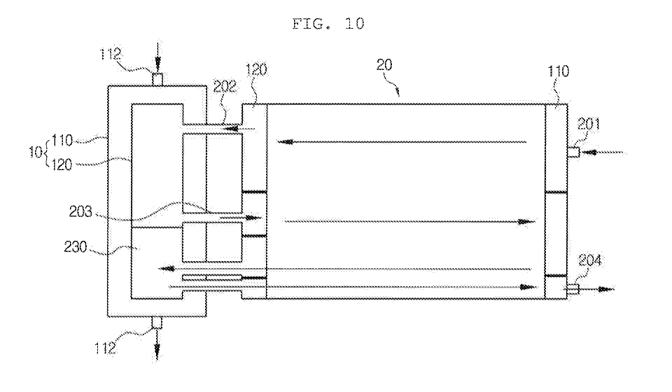

Meanwhile, in the refrigeration cycle of the vehicle air conditioner illustrated in FIG. 10, the gas-liquid separator 230 of the air cooling type condenser 20 and the water cooling type condenser 10 are integrally formed. When the water cooling type condenser 10 is formed in the shell tube type having the double tube form, two internal tubes are provided in an external tube, in which one may serve as the heat exchanger of the water cooling type condenser 10 and the other may serve as the gas-liquid separator 230.

In addition, in the water cooling type condenser 10, an upper portion in one tube may be used as the water cooling heat exchanger and a lower portion therein may be used as the gas-liquid separator.

In addition, the example in which the gas-liquid separator 230 and the water cooling type condenser 10 are integrally formed may be variously implemented according to the type of the water cooling type condenser 10.

Accordingly, the refrigeration cycle of the vehicle air conditioner of the present invention includes both the water cooling type condenser 10 and the air cooling type condenser 20 and is configured so that the refrigerant, which is in the abnormal state after passing through the condensed region A1 of the air cooling type condenser 20, passes through the water cooling type condenser 10 and then passes through the supercooled region A2 of the air cooling type condenser 20, thereby improving the cooling performance.

That is, according to the present invention, in order to supplement the disadvantage of the water cooling type condenser 10 in which the cooling efficiency is reduced when the water cooling type condenser 10 is used alone but the stable cooling performance may be ensured, both the water cooling type condenser 10 and the air cooling type condenser 20 are used but the water cooling type condenser 10 is disposed in the abnormal region of the refrigerant having the high heat exchange efficiency, thereby improving the cooling performance.

The present invention is not limited to the above-mentioned embodiments but may be variously applied, and may be variously modified by those skilled in the art to which the present invention pertains without departing from the gist of the present invention claimed in the claims.

### DETAILED DESCRIPTION OF MAIN ELEMENTS

C: Compressor
T: Expansion valve
E: Evaporator
P: Refrigerant pipe
A1: Condensed region,
A2: Supercooled region
10: Water cooling type condenser
110: Housing part
111: Cooling water inlet,
112: Cooling water outlet
120: Water cooling heat exchanger
20: Air cooling type condenser
201: First inlet,
202: First outlet
203: Second inlet,
204: Second outlet
210: First header tank,
220: Second header tank
230: Gas-liquid separator
300: Baffle

1. A refrigeration cycle of a vehicle air conditioner, comprising:
a compressor compressing a refrigerant;
a water cooling type condenser exchanging heat between cooling water introduced from a low-temperature radiator and a refrigerant passing through the compressor;
an air cooling type condenser introduced with the refrigerant, compressed by the compressor and discharged, through a first inlet to exchange heat between the refrigerant and air so as to condense the refrigerant, discharging the refrigerant passing through a condensed region through a first outlet to pass the refrigerant through the water cooling type condenser, introduced with the refrigerant through a second inlet, and then passing the refrigerant through a supercooled region to exchange heat between the refrigerant and the air;
an expansion valve expanding the refrigerant that passes through the supercooled region of the air cooling type condenser and is then discharged through a second outlet; and
an evaporator evaporating the refrigerant that is expanded by the expansion valve and discharged, all of which are connected to each other by a refrigerant pipe.

2. The refrigeration cycle of a vehicle air conditioner of claim 1, wherein the refrigerant discharged through the first outlet of the air cooling type condenser to be introduced into the water cooling type condenser is in an abnormal state in which gas and liquid are mixed.

3. The refrigeration cycle of a vehicle air conditioner of claim 2, wherein the air cooling type condenser includes:
a first header tank and a second header tank having the refrigerant introduced or discharged thereinto or therefrom and disposed in parallel while being spaced apart from each other by a predetermined distance in a height direction or a longitudinal direction;
a plurality of tubes having both ends fixed to the first and second header tanks and to form a refrigerant channel;
a plurality of fins interposed between the tubes; and
a gas-liquid separator connected to the second header tank and having a body introduced with the refrigerant passing through the water cooling type condenser to perform gas-liquid separation.

4. The refrigeration cycle of a vehicle air conditioner of claim 3, wherein in the air cooling type condenser, an inside of the first header tank or the second header tank is provided with a baffle and the refrigerant channel is controlled depending on the number and positions of baffles.

5. The refrigeration cycle of a vehicle air conditioner of claim 4, wherein the refrigerant passing through some of the condensed region of the air cooling type condenser passes through the water cooling type condenser, passes through the rest of the condensed region of the air cooling type condenser, and then is introduced into the gas-liquid separator.

6. The refrigeration cycle of a vehicle air conditioner of claim 5, wherein in the air cooling type condenser, a first inlet, the first outlet, the second inlet, and the second outlet are formed in the first header tank.

7. The refrigeration cycle of a vehicle air conditioner of claim 6, wherein in the air cooling type condenser, the first outlet is disposed above the first inlet, and the second inlet and the second outlet are sequentially disposed under the first inlet.

8. The refrigeration cycle of a vehicle air conditioner of claim 6, wherein the first header tank of the air cooling type condenser is provided with the water cooling type condenser.

9. The refrigeration cycle of a vehicle air conditioner of claim 5, wherein in the air cooling type condenser, the first inlet and the second outlet are formed in the first header tank and the first outlet and the second inlet are formed in the second header tank.

10. The refrigeration cycle of a vehicle air conditioner of claim 9, wherein the second header tank of the air cooling type condenser is provided with the water cooling type condenser.

11. The refrigeration cycle of a vehicle air conditioner of claim 4, wherein the refrigerant passing through the whole of the condensed region of the air cooling type condenser passes through the water cooling type condenser, and then is introduced into the gas-liquid separator.

12. The refrigeration cycle of a vehicle air conditioner of claim 11, wherein in the air cooling type condenser, a first inlet, the first outlet, and the second outlet are formed in the first header tank or the second header tank, and the second inlet is formed in the gas-liquid separator.

13. The refrigeration cycle of a vehicle air conditioner of claim 1, wherein the water cooling type condenser includes:
a housing part provided with a cooling water inlet and a cooling water outlet; and
a fin-tube type water cooling heat exchanger that is accommodated in the housing part and has the refrigerant discharged through the first outlet introduced thereinto to circulate the refrigerant so as to exchange heat between the refrigerant and the cooling water.

14. The refrigeration cycle of a vehicle air conditioner of claim 13, wherein the water cooling heat exchanger is formed in any one of a shell-tube type and a plate type.

15. The refrigeration cycle of a vehicle air conditioner of claim 3, wherein the gas-liquid separator and the water cooling type condenser are integrally formed.
